(19) United States
(12) Patent Application Publication
(10) Pub. No.: US 2007/0192316 A1
(43) Pub. Date: Aug. 16, 2007

(54) High performance vector search engine based on dynamic multi-transformation coefficient traversal

(75) Inventors: Kou Chu Lee, Princeton Junction, NJ (US); Hasan Timucin Ozdemir, Plainsboro, NJ (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/354,773

(22) Filed: Feb. 15, 2006

(51) Int. Cl. G06F 17/30

(52) U.S. Cl. 707/6

(57) ABSTRACT

A similarity search engine includes a transformation module performing multiple iterations of transformation on a high dimensional vector data set. A scanning module supports dynamic selection of coefficients generated by the multiple iterations, and store and utilize search results in subsequent search operations. A dynamic query vector tree constructed from one or more input queries enhances search performance using multiple scans. Subsequent scans have a reduced candidate vector set and increased nearest neighbor vectors in a query vector set compared to previous scans.

### FIELD

The present disclosure generally relates to vector search engines, and relates in particular to a high performance vector search engine based on dynamic multi-transformation coefficient traversal.

### BACKGROUND

The statements in this section merely provide background information related to the present disclosure and may not constitute prior art.

It is well known to experts in the field that it is hard to get sub-linear similarity search operation over a high dimensional large vector data set. Research results have been obtained on limited data sets such as time series data and face image data, etc. These results mainly focused on variations of statistical clustering analysis such as: (a) “static” supporting vector analysis that divides the data set into smaller numbers of clusters to facilitate the search operation; or (b) “dynamic” tree structures to support a hierarchical search. Due to the phenomenon of high dimensionality of large vector data where the distance between all the vectors tends to be concentrating to a narrower standard deviation centering on the average distance, all the clustering and tree based partitioning methods are not effective for high dimensional large vector data sets. Therefore, it is necessary to investigate new methods that can improve the speed and accuracy of the similarity search operation for high dimensional large vector data sets.

Independent from the statistical analysis methods developed for similarity search over large vector data sets, Wavelet transformation has been applied to various problems of signal/image processing. The advantages of Wavelet transformation include: (a) generality of the transformation; (b) adaptability of the transformation; (c) transformation is hierarchical; (d) transformation is loss-free; and (e) efficiency of the transformation.

### SUMMARY

A similarity search engine includes a transformation module performing multiple iterations of transformation on a high dimensional vector data set. A scanning module supports dynamic selection of coefficients generated by the multiple iterations, and store and utilize search results in subsequent search operations. A dynamic query vector tree constructed from one or more input queries enhances search performance using multiple scans. Subsequent scans have a reduced candidate vector set and increased nearest neighbor vectors in a query vector set compared to previous scans.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a two-dimensional graph illustration a vector search space; and

FIG. 2 is a block diagram illustrating functional components of a similarity search engine.

### DETAILED DESCRIPTION

The following description is merely exemplary in nature and is not intended to limit the present disclosure, application, or uses.

A new set of information can be generated by original vector data using iterative transformation. Traditionally, signal analysis is done based on coefficients generated from one iteration of transformation, such as Harr and Fourier transformation. While one iteration of a transformation can achieve multiple resolution and distance preserving properties, more information can be extracted from the data by observing coefficients over multiple iterations of transformations.

For example, for a n dimensional vector V, one can apply Harr transform Harr(V), c times to get the c-transformed vector V_{c} (i.e., V_{c}=Harr(Harr(Harr( . . . (V))) for c complete iterations). This c iteration of Harr transform generates (n×c) coefficients which can be labeled as aᵢⱼ where 0<i<c+1 and 0<j<n+1. Then, one can select k coefficients to form an approximation vector from the (k×c) coefficients (i.e., approximation vector is {a(ij)} where i is the i-th coefficient of j-th Harr transform of original vector). One can also quantize the elements of each vector using a lower number of bits. In particular, it is possible to use quantization(projection(V)) to describe a final approximation vector. The approximation vector can be much smaller than the original vector, but, due to multiple iteration of transformation and selection of coefficients, it can retain a dense and sufficient representation of the information contained in the original vector to support similarity search operations with good accuracy.

Based on the idea explained above, a similarity search engine can allow a user to select a best method for a specific set of applications dynamically. In particular, the search engine can support dynamic selection of coefficients generated by multiple iterations of transformation on a high dimensional vector data set. The search engine can also store and utilize some of the search results in the following search operations. The stored reference vector set (due to the previous search operations) can speed up the search operation. Further, the search engine can build a dynamic query vector tree from one or more input queries to enhance search performance using multiple scans, each with a reduced candidate vector set and increased nearest neighbor vectors in the query set.

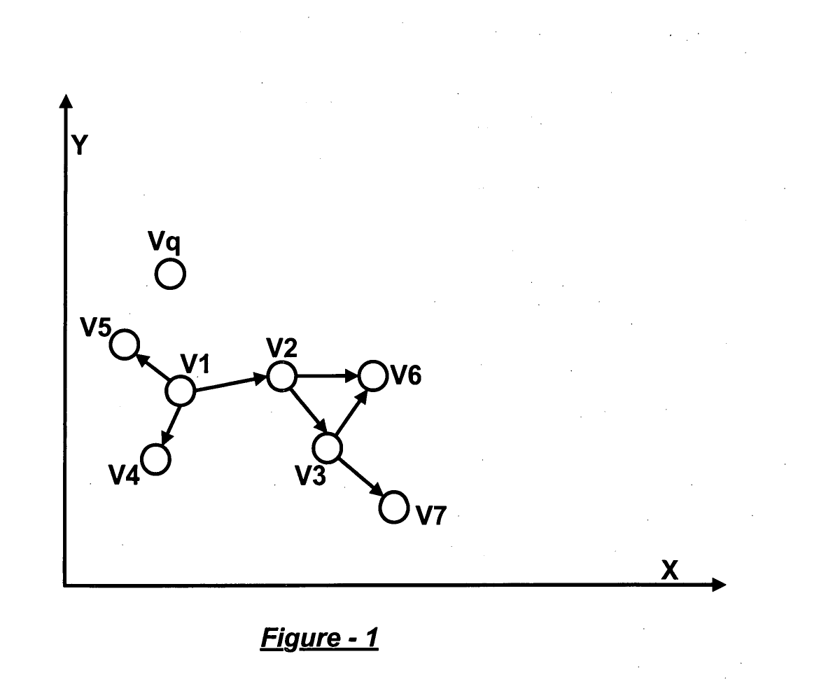

Referring to FIG. 1, the search engine can perform multiple iterations of transformation on a high dimensional vector data set to calculate more distribution characteristics of the vector data set than that of single transformation. For example, the coefficients from multiple iterations can be partitioned and ranked so that significant coefficients can be selected to form the approximation vector set. Selection of significant coefficients can be based on a standard deviation measure of sample data that has been processed up to date or a training data set derived from the distribution of the coefficients generated from the iterative transformation process. The selected coefficients define how the projection is applied on the raw data to form the approximate vector representation. Since the approximate vector representation contains a lower number of elements than the original vector, the result is a set of approximations vector that contains a much lower number of elements in comparison to the original vectors. Furthermore, after applying quantization, the number of bits needed for each element of the vector is also reduced. The combination of quantization and selection of coefficients reduces the total size of the storage needed to store the approximation vector and increases the speed of the comparison operation.

To increase the efficiency of the search operation, the architecture also stores the nearest neighbor information obtained from previous nearest neighbor search results into each approximation vector. This nearest neighbor information is collected in an index file and represented in FIG. 1 as links between vectors V1-V7. As more search queries are performed, there is more information about the nearest neighbor for more approximation vectors. When the amount of stored nearest neighbor information increases, the possibility of finding a node (where node represents a data point in high dimensional space) along with multiple nearest neighbors increases. If a similarity measure is given, one may not need to go though the whole approximation vector set in order to find the first few nearest neighbors of an approximation vector that is similar to the query vector Vq within a small error bound defined in priori. The probability is high that if an approximation vector is close to the given query vector, then, one of the nearest neighbors of this approximation vector will be one of the nearest neighbors of the given query vector Vq.

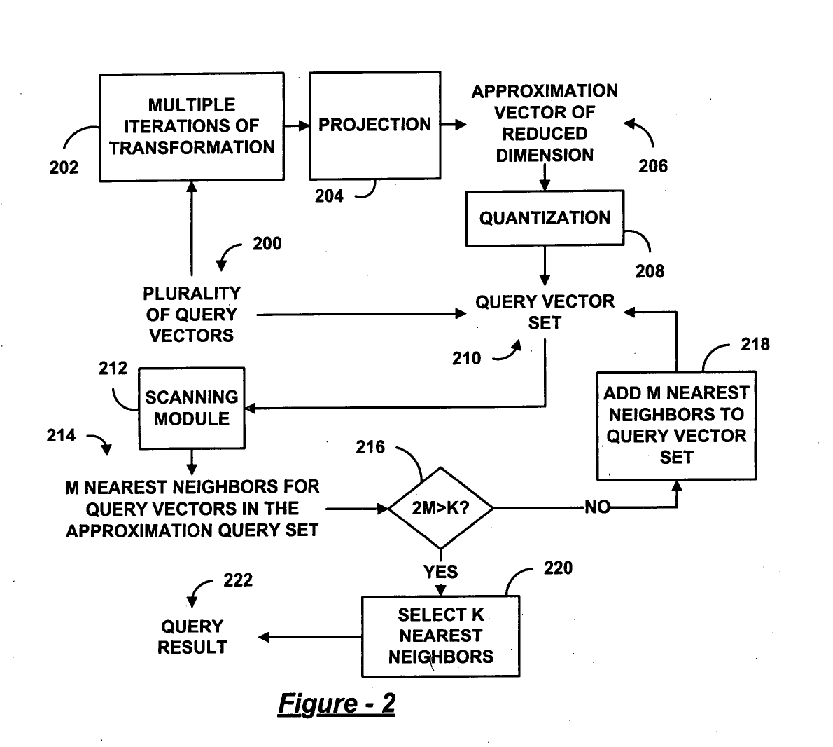

Turning now to FIG. 2, one can also perform the similarity search operation by using the given query vector 200 as follows: (a) for a given query vector 200, generate j iterations of transformation 202 and perform projection 204 on the vector to obtain an approximation vector 206 of reduced dimension; (b) (i) perform quantization 208 on each element of the approximation vector 206; (ii) put the initial query vector 200 with its approximate representation (i.e., the quantized approximation vector) into a query vector set 210, letting the number of query vectors in this set be M; (c) (i) at 212, scan the approximation vector data set (i.e., the approximation representations in the query set) to find the M nearest neighbor vectors 220 by using the query vector set 210 and the error bound; (ii) calculate the distance based on the distance between a vector in the approximation vector data set and the query vectors in the query vector set 210; (iii) at the end of the scan, the total number of vectors (query vector set and the selected neighbor vectors) becomes 2M; (d) (i) for the search of K nearest neighbors, if the 2M<=K at 216, then at 218 include the M vectors found in the step (c) into the query vector set 210 with their proper approximate representation; (ii) go to step (c) and, if the 2M>K at 216, then select at 220 K vectors out of 2M vectors as a query result 222.

This operation returns vectors close to each other rather than vectors close to only one query point. The maximum number of scans at step (c) is bounded by ┌log(K)┐ iterations.

The advantages of this search engine over existing art are numerous. For example, the selection of dominant coefficients is from multiple transformations rather than one transformation. Dominant coefficient selection based on standard deviation of coefficients across the sample vector set allows for a statistically more accurate calculation of L2 (Euclidian) distance. Separating the uniformly distributed elements and obtaining approximation using a quantization method can further increase the accuracy of the distance calculation, at the same time reducing the total amount of data bits involved in the calculation.

Also, by storing nearest neighbor information accumulatively into the approximation vectors, the search engine can provide a fast retrieval of nearest neighbor by using the computation results obtained from previous search operations.

Further, the query tree supports simultaneous comparison of an input approximation vector against a query vector and its' associated nearest neighbor vectors. If the input vector is similar to the query vector and its' near neighbor, it is more likely that the original vector will be similar to the query vector.

What is claimed is:

1. A similarity search engine, comprising:
a transformation module operable to perform multiple iterations of transformation on a high dimensional vector data set;
a scanning module operable to support dynamic selection of coefficients generated by the multiple iterations, wherein said scanning module is operable to store and utilize at least part of search results in subsequent search operations; and
a dynamic query vector tree constructed from one or more input queries and operable to enhance search performance using multiple scans, wherein subsequent scans have a reduced candidate vector set and increased nearest neighbor vectors in a query vector set compared to previous scans.

2. The search engine of claim 1, wherein said transformation module is adapted to partition and rank coefficients from the multiple iterations so that significant coefficients can be selected to form an approximation vector.

3. The search engine of claim 2, wherein selection of significant coefficients is based on at least one of a standard deviation measure of sample data that has been processed up to date or a training data set.

4. The search engine of claim 2, wherein selected coefficients define how projection is applied on raw data to form the approximation vector.

5. The search engine of claim 2, wherein said scanning module stores nearest neighbor information obtained from previous nearest neighbor search results into each approximation vector.

6. The search engine of claim 1, wherein said transformation module, for a given query vector, generates j iterations of transformation and performs projection on the query vector to obtain an approximation vector of reduced dimension.

7. The search engine of claim 6, wherein said transformation module performs quantization on each element of the approximation vector, and puts the query vector with its approximation representation into a query vector set, letting a number of query vectors in the query vector set be M.

8. The search engine of claim 7, wherein said scanning module scans the approximation representations in the query vector set to find M nearest neighbor vectors by using an error bound and calculating distance between a vector in the approximation representations and query vectors in the query vector set, thereby obtaining 2M vectors, including the M nearest neighbors and the M query vectors in the query vector set.

9. The search engine of claim 8, wherein said scanning module, if 2M<=K, includes the M nearest neighbor vectors into the query vector set with their proper approximate representation, thereby increasing M, and then perform scans again.

10. The search engine of claim 8, wherein said scanning module, if 2M>K, selects K vectors out of the 2M vectors as a query result.

11. A method of operation for a search engine, comprising:
for a given query vector, generating j iterations of transformation and performing projection on the query vector to obtain an approximation vector of reduced dimension.

12. The method of claim 11, further comprising:
performing quantization on each element of the approximation vector, and putting the query vector with its approximation representation into a query vector set, letting a number of query vectors in the query vector set be M.

13. The method of claim 12, further comprising:
scanning the approximation representations in the query vector set to find M nearest neighbor vectors by using an error bound and calculating distance between a vector in the approximation representations and query vectors in the query vector set, thereby obtaining 2M vectors, including the M nearest neighbors and the M query vectors in the query vector set.

14. The method of claim 13, further comprising:
if 2M<=K, then including the M nearest neighbor vectors into the query vector set with their proper approximate representation, thereby increasing M, and scanning again;

15. The method of claim 13, further comprising:
if 2M>K, then selecting K vectors out of the 2M vectors as a query result.

16. A method of operation for a similarity search engine, comprising:
performing multiple iterations of transformation on a high dimensional vector data set;
supporting dynamic selection of coefficients generated by the multiple iterations; and
storing and utilizing at least part of search results in subsequent search operations.

17. The method of claim 16, further comprising
enhancing search performance using multiple scans, wherein subsequent scans have a reduced candidate vector set and increased nearest neighbor vectors in a query vector set compared to previous scans.

18. The method of claim 16, further comprising:
partitioning and ranking coefficients from the multiple iterations so that significant coefficients can be selected to form an approximation vector.

19. The method of claim 18, further comprising:
selecting significant coefficients based on at least one of a standard deviation measure of sample data that has been processed up to date or a training data set.

20. The method of claim 18, further comprising performing projection to form the approximation vector.

21. The method of claim 18, further comprising storing nearest neighbor information obtained from previous nearest neighbor search results into each approximation vector.
